(19) United States
(12) Patent Application Publication
(10) Pub. No.: US 2005/0249844 A1
(43) Pub. Date: Nov. 10, 2005

(54) Cocktail garnish sachet and method of use thereof

(76) Inventor: Jennifer Rosskamp, Fairburn, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/838,675

(22) Filed: May 4, 2004

(51) Int. Cl. A23B 4/00

(52) U.S. Cl. 426/115

(57) ABSTRACT

A cocktail garnish and method of serving same, wherein the garnish is pre-speared on a spiked member and sealed within a package for freshness. The garnish can then be removed from the package when desired and utilized for complementing a cocktail beverage. The garnish may be packaged in a series of packs for storage, wherein the packs may be removed one at a time by separating one from the other. The packs may further carry advertising or other indicia thereon.

### TECHNICAL FIELD

The present invention relates generally to devices and methods for packaging and serving cocktail garnishes, and more specifically to a cocktail garnish sachet and method of use thereof, for providing vacuum-sealed plastic-packaged vegetables and/or fruits for unitary service.

### BACKGROUND OF THE INVENTION

Many cocktail formulas include some form of garnish; most notably, lime, orange or lemon slices for assorted cocktails, olives and/or onions for martinis, and cherries for manhattans. In order to secure such garnishes to decorate a cocktail, a toothpick or spear is often utilized (such as that shown by U.S. Design Pat. No. 438,069 to Williamson et al.), wherein the spear passes through the garnish, retaining the garnish thereupon.

Since such garnishes are placed in drinks and/or subsequently eaten, hygiene of the garnish is of great importance. Unfortunately, typical methods of packaging garnishes militate against maintaining the garnishes in hygienic condition. That is, since such garnishes are typically packaged in large quantities, often in glass or plastic containers, the drink preparer must fish or pluck the garnish from the container; thus, requiring the use of an implement or, as is often the case, fingers. Accordingly, after the first garnish is extracted from its container via potentially germ-laden fingers, the remaining garnishes, and/or pickling liquid in which such garnishes are often kept, are in less than sanitary condition.

Contamination of such garnishes is further particularly notable in a tavern atmosphere, where garnishes are typically left out in the open, often on a partitioned tray or basket, and unprotected from spills, drips and/or exhaust breath of patrons and bartenders.

Exposure of garnishes to open air is also detrimental to the maintenance of garnish freshness. Although garnishes are often pickled in some fashion, garnishes will still lose freshness over time unless retained in constant fluid surroundings. Unfortunately, however, because it is often desirable to divide a container of garnishes into different locations, separation of the garnishes from the original pickling fluids is inevitable, and, as such, may result in garnishes drying out and/or losing freshness.

In the hotel industry, mini-bars/refrigerators are becoming more and more prevalent in rooms. A large variety of items are sold through the mini-bar concept, namely, beer, soft drinks, wine, snacks and candies. Additionally, liquor is often sold with mixers that complement the liquor. Drinks made using the contents of a mini-bar may well require a garnish for completeness. It is therefore desirable to provide a small quantity of fresh, unitary-packaged, garnishes for the hotel guest. Unfortunately, however, most hotel patrons are forced to “call down” to the hotel kitchen and request the room delivery of selected garnishes, wherein such garnishes are typically retrieved from the kitchen's “common” or “cooking” supply.

In the airline industry, cocktails are often served in-flight. Containers, such as glass jars, are bulky, unsanitary and hazardous, particularly in such a confined area; liquids can spill from the containers and, if made of glass, the containers can shatter. Moreover, due to time constraints during a flight, it is desirable that drink servings be expeditiously and conveniently served. It is currently necessary for a flight attendant to retrieve a garnish and spear it with a toothpick, or the like, prior to placing the garnish into a drink. Such a procedure is highly inconvenient, time-consuming and may present the aforementioned unsanitary handling of the garnishes.

Packaging for liquid fruit and/or vegetable-based condiments, and other semi-solid materials, such as, salad dressing, mayonnaise, mustard and ketchup are well known. U.S. Pat. No. 4,644,732 to Morton describes such a package. While the device of Morton '731 might suit liquid materials, it lacks a carrying device such as a spear for holding the contents once removed, and is further unsuitable for pre-speared garnishes as the spear may puncture and/or perforate the packaging.

Other food containing devices include salad vegetables stacked on a tubular wand and contained within a cup and lid as disclosed by U.S. Pat. No. 3,821,425 to Russell. The device of Russell '425 lacks the ability to retain freshness of the vegetables enclosed therein, is bulky, is unsuitable for multiple unit packaging, and further requires an additional exterior component, namely, a bulb containing salad dressing.

As convenience becomes increasingly important, the ability to serve unitary servings of garnishes or to conveniently vend garnishes becomes paramount. Furthermore, by having the ability to choose whether a garnish is required and having the presence of a vending machine to purchase from, customers who do not require such garnishes and are opposed to paying for something that they do not utilize are relieved of the cost, while those who do require a garnish can purchase same from the vending machine.

Therefore, it is readily apparent that there is a need for a pre-packaged cocktail garnish, and, more particularly, for a method of garnishing cocktails utilizing a pre-speared garnish fruit or vegetable.

### BRIEF SUMMARY OF THE INVENTION

Briefly described, in a preferred embodiment, the present invention overcomes the above-mentioned disadvantages and meets the recognized need for such a device by providing a cocktail garnish sachet and method of use thereof for providing a garnish in a unitary prepackaged form ready for use, while at the same time maintaining the freshness of the garnish within the package.

More specifically, the present invention is a pre-speared garnish within a sealed plastic package. The garnish is typically one or more olives, one or more onions, or one or more cherries, through which a toothpick or other spearing device has been inserted. Other suitable garnishes that could be prepackaged include lemon, lime and orange slices. The plastic package has a reinforcement therein for preventing the spearing device from penetrating and breaking the package seal.

The garnish packet could be produced as unitary packages or in a strip of unitary packages separated via a perforated severance line. As such, the unitary package is utilized in serving a drink by opening and removing the garnish therefrom, or alternately, by serving the drink with the garnish packet on the side so that the consumer can sanitarily remove and apply the garnish to his/her cocktail.

The garnish and method of the present invention is particularly suited for convenient serving in a variety of food service industries. A particularly useful application of the present invention is in the airline industry, wherein cocktails may be served without having to fish or otherwise retrieve a garnish out of a liquid-containing container. By providing single-serving prepackaged garnishes, cabin crew need only to remove the garnish from a dry box and place the garnish on the drink consumer's platter.

With regard to the hotel industry, such single use portions of garnishes may be included in hotel room minibars, wherein the hotel room occupant would no longer need to order from room service in order to have a properly garnished cocktail, nor does the hotel have to provide various jars of condiments within the minibar. By retrieving a prepackaged garnish, the hotel room occupant can embellish a drink with a fresh, sanitary garnish.

With regard to the tavern industry, bartenders are able to serve fresh garnishes without having to keep large open jars in unsanitary conditions, and will experience less waste due to maintenance of fresh garnishes by the present invention.

Various other industries exist that would benefit from the present invention, such as, for exemplary purposes only, limousine services and cruise ships. Because of the limited space in a limousine, and the lack of washing facilities to maintain cleanliness, pre-packaged garnishes will provide simple, easy-to-use drink accompaniments. On board a cruise ship, storage will be greatly improved, no longer requiring wet storage, such as glass containers, and their concomitant hazards.

Additionally, the unitary packaging of such pre-speared garnishes is highly suitable for vending. By providing a means to obtain garnishes via vending, only those customers who require garnishes need to pay for them, wherein such customers will be provided with fresher, more sanitary garnishes.

Liquor stores will also now be able to provide a customer with a pre-packaged garnish to accompany standard liquor purchases, or the pre-packaged garnish may also be bundled with liquor, particularly the miniature, single serving size bottle.

In addition to providing a fresh garnish, the pre-speared garnish of the present invention can serve as an advertising means, wherein a logo or name may be placed on both the package and the spearing device.

Accordingly, a feature and advantage of the present invention is its ability to maintain the freshness of garnish fruits and vegetables.

Another feature and advantage of the present invention is its ability to be dispensed via a vending machine.

Another feature and advantage of the present invention is that it would be particularly suitable for marketing in a specialty food store.

Still another feature and advantage of the present invention is its ability to provide simple, easy-to-handle garnishes for single serving use.

Yet another feature and advantage of the present invention is its ability to be utilized in confined environments.

Yet still another feature and advantage of the present invention is convenience and timesavings.

A further feature and advantage of the present invention is its ability to carry advertising.

Another feature and advantage of the present invention is that it reduces waste caused by garnishes becoming stale or unsanitary.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A is a front view of a prepackaged cocktail garnish according to a preferred embodiment of the present invention;

FIG. 1B is a front view of a prepackaged cocktail garnish according to a preferred embodiment of the present invention;

FIG. 1C is a front view of a prepackaged cocktail garnish according to a preferred embodiment of the present invention;

FIG. 2 is a front view of a continuous strip of prepackaged cocktail garnishes according to an alternate embodiment of the present invention;

FIG. 3 is a perspective view of a prepackaged garnish according to a preferred embodiment of the present invention, shown in use; and

FIG. 4 is a front view of an alternate embodiment of the present invention.

### DETAILED DESCRIPTION OF THE PREFERRED AND SELECTED ALTERNATIVE EMBODIMENTS

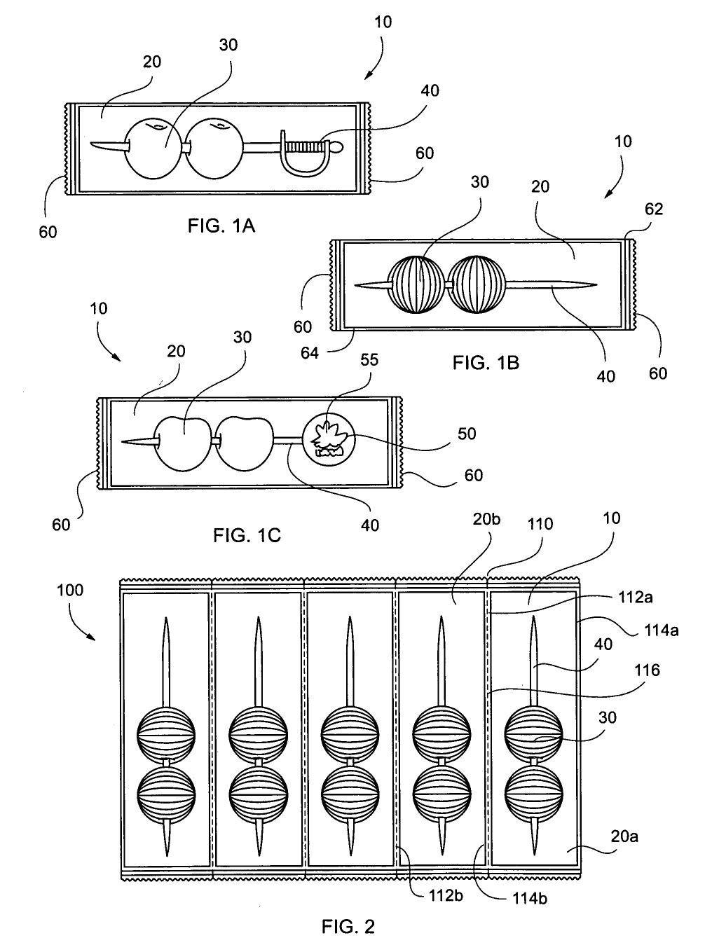

In describing the preferred and selected alternate embodiments of the present invention, as illustrated in FIGS. 1A-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-1C, the present invention in a preferred embodiment comprises cocktail garnish pack 10, wherein cocktail garnish pack 10 comprises package 20, garnish 30, and spiked member 40, and wherein spiked member 40 can selectively further include display member 50 with indicia 55 thereon. Package 20 further has tear notches 60, carried at first end 62 and second end 64 of package 20, to facilitate opening of package 20 by tearing. Package 20 can also selectively carry indicia thereon, such as, for exemplary purposes only, advertising and/or nutritional information.

It will be recognized by those skilled in the art that individual cocktail garnish packs 10 could suitably be furnished via delivery from a vending machine.

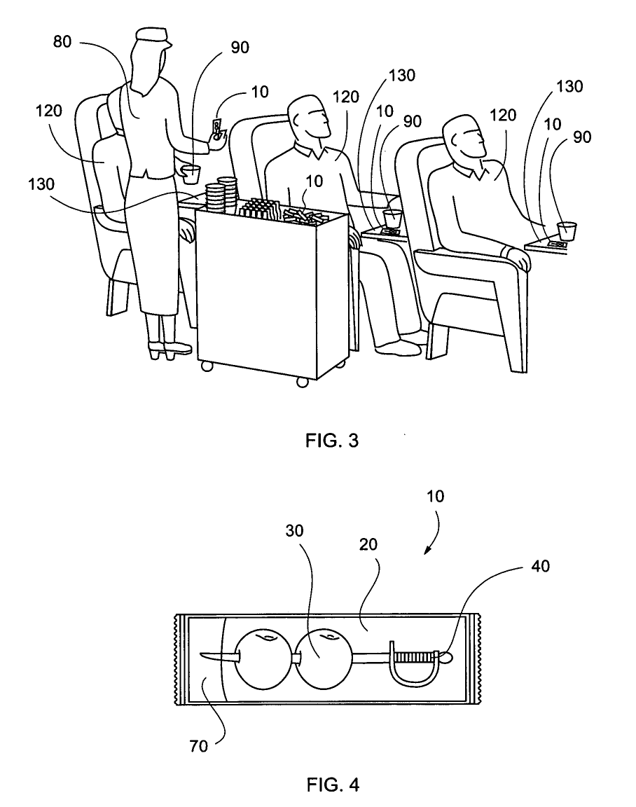

Referring now to FIG. 2, cocktail garnish pack 10 may be selectively assembled as strip 100 of garnish packs 10, wherein strip 100 comprises a plurality of cocktail garnish packs 10 connected together, and separable via perforations or separation lines 110. Packages 20a and 20b comprise first edges 112a and 112b, respectively, and second edges 114a and 114b, respectively, wherein separation line 110 is formed at juncture 116 of first edge 112a of package 20a and second edge 114b of package 20b. By tearing along separation line 110, individual packs 10 can be separated from strip 100 for use. Strip 100 can be readily packaged such that cocktail garnish packs 10 can be fed or dispersed through an orifice of a container and be removed individually as needed.

In use, as depicted in FIG. 3, cocktail garnish pack 10 is utilized by aircrew member 80 to provide cocktail garnish pack 10 for use to complement drink 90 being served to passenger 120, wherein aircrew member 80 places garnish pack 10 and drink 90 on serving tray 130 for passenger 120 for selective use of same.

Referring now more specifically to FIG. 4, illustrated therein is an alternate embodiment of cocktail garnish pack 10, wherein the alternate embodiment of FIG. 4 is substantially equivalent in form and function to that of the preferred embodiment detailed and illustrated in FIGS. 1A-3, except as hereinafter specifically referenced. Specifically, the embodiment of FIG. 4 comprises cocktail garnish pack 10, wherein cocktail garnish pack 10 further comprises reinforced section 70. Reinforced section could be a second layer of material from which package 20 is made, or other means for reinforcement. Reinforced section 70 serves to prevent puncturing or perforation of cocktail garnish pack 10 by spiked member 40.

It is anticipated in an alternate embodiment that the present invention could comprise a resealable package, wherein a releasable/resealable adhesive, or a rib-and-groove closure, or the like, is utilized.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. A method of serving a beverage comprising the step of:
serving a single garnish serving in a sealed package, said single garnish serving carried by a spiked member within said sealed package, wherein garnish may be served without human contact, and coincidentally serving the beverage.

2. The method of claim 1, wherein said step of serving said single garnish serving in a sealed package comprises the steps of:
a. pouring the beverage;
b. obtaining said packaged, pre-spiked single garnish serving; and
c. providing said beverage and said packaged, pre-spiked single garnish serving to the consumer.

3. The method of claim 2, further comprising the steps of:
opening said garnish serving package; and
adding said single garnish serving to the beverage.

4. (canceled)

5. The method of claim 1, wherein said spiked member carries indicia thereon.

6. The method of claim 1, wherein said sealed package carries indicia thereon.

7. The method of claim 1, wherein said sealed package further comprises a reinforced section adapted to receive a spiked member.

8. A method of making a packaged garnish, comprising the steps of:
a. obtaining an individual garnish serving;
b. inserting a spiked member through said individual garnish serving;
c. obtaining a pouch;
d. inserting said spiked, individual garnish serving into said pouch, wherein garnish may be subsequently served without human contact; and
e. sealing said pouch.

9. The method of making of claim 8, wherein said pouch comprises indicia carried thereon.

10. The method of making of claim 8, wherein said spiked member comprises indicia carried thereon.

11. The method of making of claim 8, wherein said pouch further comprises a reinforced section.

12. A single-serving garnish prepack comprising:
a garnish portion suitable for consumption by one individual in one beverage serving;
a spiked member, wherein said garnish portion is impaled on said spiked member, and wherein garnish may be served without human contact; and
a sealed pouch containing said spiked garnish serving.

13. The garnish prepack of claim 12, wherein said sealing pouch comprises a reinforced section.

14. The garnish prepack of claim 12, wherein said sealing pouch comprises a plurality of sealing sections.

15. The garnish prepack of claim 12, wherein said sealing pouch further comprises indicia thereon.

16. The garnish prepack of claim 12, wherein said spiked member further comprises indicia thereon.

17. The garnish prepack of claim 12, wherein said garnish prepack is adapted for delivery via a vending machine.

18. The garnish prepack of claim 14, wherein said at least one garnish is selected from the group consisting of at least one olive, at least one cherry, at least one onion, at least one slice of lime, at least one slice of lemon, at least one slice of orange, and combinations thereof.

19. The garnish prepack of claim 14, wherein said plurality of sections lie adjacent one another.

20. The garnish prepack of claim 15, wherein said plurality of sealing sections comprises separation lines between adjacent sections.

21. The garnish prepack of claim 12, wherein said garnish prepack is bundled with a bottle of liquor.
